(19) United States
(12) Patent Application Publication
(10) Pub. No.: US 2010/0235851 A1
(43) Pub. Date: Sep. 16, 2010

(54) Flexible Optical Disc with Outer Edge Ring

(75) Inventor: Hao Ding, Milpitas, CA (US)

Correspondence Address: PATENT LAW GROUP LLP, 2635 NORTH FIRST STREET, SUITE 223, SAN JOSE, CA, 95134, US

(73) Assignee: GLOBAL PUBLISHING INC., Fremont, CA (US)

(21) Appl. No.: 12/719,803

(22) Filed: Mar. 8, 2010

Related U.S. Application Data
(60) Provisional application No. 61/159,389, filed on Mar. 11, 2009.

(51) Int. Cl. G11B 7/24; B29C 45/00

(52) U.S. Cl. 720/718; 264/299; G9B/7

(57) ABSTRACT

An optical disc includes a substrate with a hub, a data storage area, and an outer ring. The hub defines a center hole. The data storage area extends radially from the hub body and is thinner than the hub at the thickest hub portion. The outer ring protrudes down from the outer perimeter of the data storage area. Thicknesses of the outer ring and the data storage area are of a same order of magnitude. The outer edge of the optical disc thus includes the data storage area and the outer ring.

### CROSS REFERENCE TO RELATED APPLICATIONS

This application claims the benefit of U.S. Provisional Application No. 61/159,389, entitled “To Improve the Performance of Flexible Optical Disc (VCD/CD/DVD) in Various Drives or Players,” filed on Mar. 11, 2009, which is incorporated herein by reference.

### FIELD OF INVENTION

This invention relates to laser-readable optical discs.

### DESCRIPTION OF RELATED ART

FIG. 1 illustrates a conventional laser-readable optical disc 100 having a center hole 102 (also referred to as a “spindle hole”) and a stacking ring 104 protruding down from the disc bottom surface. Optical disc 100 includes a disc substrate, a metal layer on the substrate, a lacquer layer on the metal layer, and any optional artwork printed on the lacquer layer. Optical disc 100 represents a compact disc (CD) or a digital video disc (DVD). CD comes in various forms, including prerecorded CD-ROM, recordable CD-R, and rewritable CD-RW. Similarly DVD comes in various forms, including prerecorded DVD-ROM, recordable DVD-R, and rewritable DVD-RW. CDs and DVDs share similar physical specifications and both use polycarbonate as the substrate material.

FIG. 2 is a cross sectional view of a conventional substrate 200 for a CD 100 (FIG. 1). Substrate 200 has a flat top surface 202 imprinted with data (presented by pits and lands between the pits), and a flat bottom surface 204 for reading the data (also referred to as a “reading side”). Substrate 200 has a diameter D206 of 120 mm and a thickness T208 of 1.2 mm. Substrate 200 defines center hole 210. Center hole 210 has a diameter D212 of 15 millimeters (mm). Substrate 200 includes stacking ring 214 protruding from the substrate bottom around center hole 210. Stacking ring 214 has a diameter D216 of 34 mm. A laser-readable data storage area extends radially from 24 to 58 mm.

FIG. 3 is a cross sectional view of a conventional substrate structure 300 for a DVD 100. Substrate structure 300 has a lower substrate 302 and an upper substrate 304 bonded on the lower disc substrate. Lower substrate 302 has a flat top surface 306 imprinted with data, a flat bottom surface 308 for reading the data, and a thickness T310 of 0.6 mm. Upper substrate 304 has a flat top surface 312, a flat bottom surface 314, and a thickness T316 of 0.6 mm. Upper substrate 304 may be blank or its top surface 312 may be imprinted with data. Substrate structure 300 has a diameter D318 of 120 mm and a thickness T320 of 1.2 mm. Substrate structure 300 defines a center hole 322. Center hole 322 has a diameter D324 of 15 mm. Substrate structure 300 includes stacking ring 326 protruding from the bottom of lower substrate 302 around center hole 322. Stacking ring 326 has a diameter D328 of 34 mm. Laser-readable data storage areas in substrates 304 and 304 extend radially from 24 to 58 mm.

While the diameter of optical disc 100 is described above as 120 mm, some special CDs and DVDs have a diameter of 80 mm. These special CDs and DVDs have data storage areas that range from 24 to 38 mm.

FIG. 4 shows a conventional mold 400 for forming substrate 200 (FIG. 2) or lower substrate 302 (FIG. 3). Mold 400 is part of a conventional plastic injection molding machine. Mold 400 includes a first mold half 402 and a second mold half 404. First mold half 402 includes recesses 406 for forming stacking ring 214 or 326. Second mold half 404 holds a master stamper 408 to imprint data onto substrate 200 or 302. FIG. 5 shows when mold 400 is closed. First mold half 404 defines a sprue bushing 502 for receiving the molten substrate material from the injection cylinder nozzle. Referring back to FIG. 4, a punch 405 cuts a central sprue 407 from substrate 200 or 302 to form center hole 210 or 322 after the substrate material hardens. Mold halves 402 and 404 are then separated and substrate 200 or 302 is removed.

### SUMMARY

In one or more embodiments of the present disclosure, an optical disc includes a substrate with a hub, a data storage area, and an outer ring. The hub defines a center hole. The data storage area extends radially from the hub body and is thinner than the hub at the thickest hub portion. The outer ring protrudes down from the outer perimeter of the data storage area. Thicknesses of the outer ring and the data storage area are of a same order of magnitude. The outer edge of the optical disc thus includes the data storage area and the outer ring.

### BRIEF DESCRIPTION OF THE DRAWINGS

In the drawings:

FIG. 1 illustrates a conventional laser-readable optical disc;

FIG. 2 is a cross sectional view of a conventional substrate for a compact disc (CD) of FIG. 1;

FIG. 3 is a cross sectional view of a conventional substrate structure, having a lower substrate and an upper substrate bonded on the lower disc substrate, for a digital video disc (DVD) of FIG. 1;

FIG. 4 shows a conventional mold for forming the substrate of FIG. 2 or the lower substrate of FIG. 3;

FIG. 5 shows the mold of FIG. 4 closed;

FIG. 6A shows a perspective top view of a flexible optical disc including a substrate in one or more embodiments of the present disclosure;

FIG. 6B shows a perspective bottom view of the disc of FIG. 6A in one or more embodiments of the present disclosure;

FIG. 7 shows a cross sectional views of a substrate in the optical disc of FIGS. 6A and 6B in one or more embodiments of the present disclosure;

FIG. 8A shows a top view of the substrate of FIG. 7 with labeled dimensions in one or more embodiments of the present disclosure;

FIG. 8B shows a cross section view of the optical disc of FIGS. 6A and 6B with labeled dimensions in one or more embodiments of the present disclosure;

FIG. 8C shows an enlarged view of FIG. 8B in one or more embodiments of the present disclosure;

FIG. 9 shows a mold for forming a substrate of FIG. 6 in one or more embodiments of the present disclosure;

FIG. 10 shows the mold of FIG. 9 closed in one or more embodiments of the present disclosure;

FIG. 11A shows a top view of a substrate with a triangular hub in one or more embodiments of the present disclosure;

FIG. 11B shows a cross sectional views of the substrate of FIG. 11A in one or more embodiments of the present disclosure;

FIG. 12A shows a top view of a substrate with a diamond-shaped hub in one or more embodiments of the present disclosure;

FIG. 12B shows a cross sectional views of the substrate of FIG. 11A in one or more embodiments of the present disclosure.

FIG. 13A shows a top view of a substrate with a hub with bumps in one or more embodiments of the present disclosure;

FIG. 13B shows a cross sectional views of the substrate of FIG. 11A in one or more embodiments of the present disclosure.

FIG. 14A shows a top view of a substrate for a hub having bumps in one or more embodiments of the present disclosure; and

FIG. 14B shows a cross sectional views of the substrate of FIG. 11A in one or more embodiments of the present disclosure.

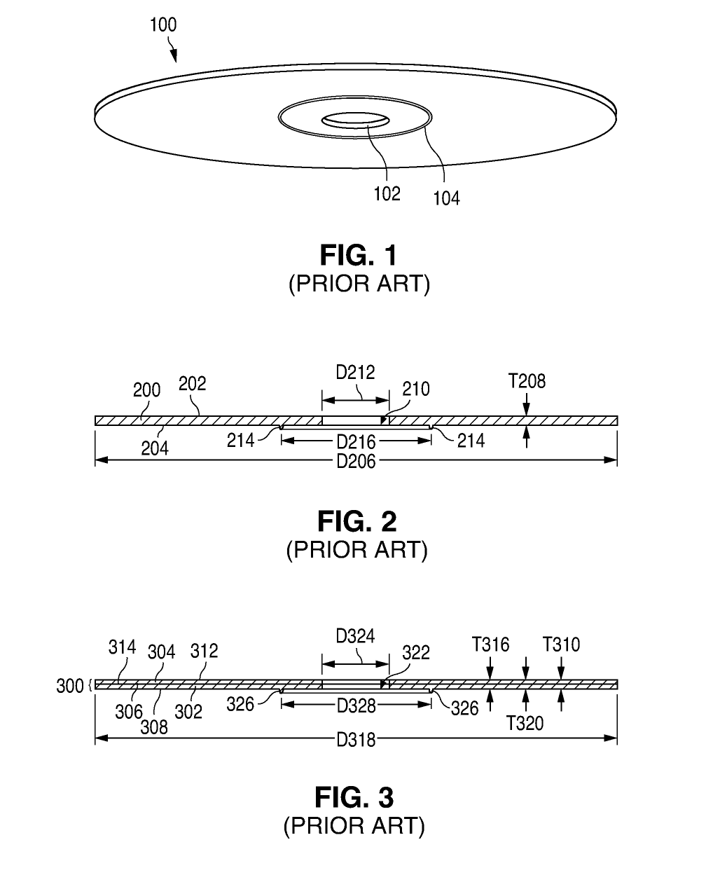

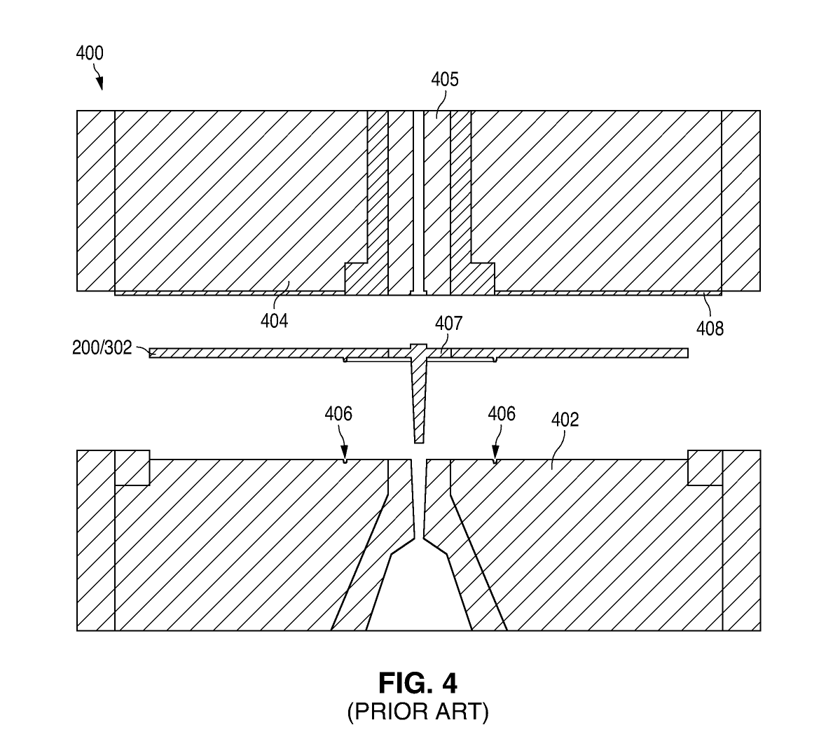

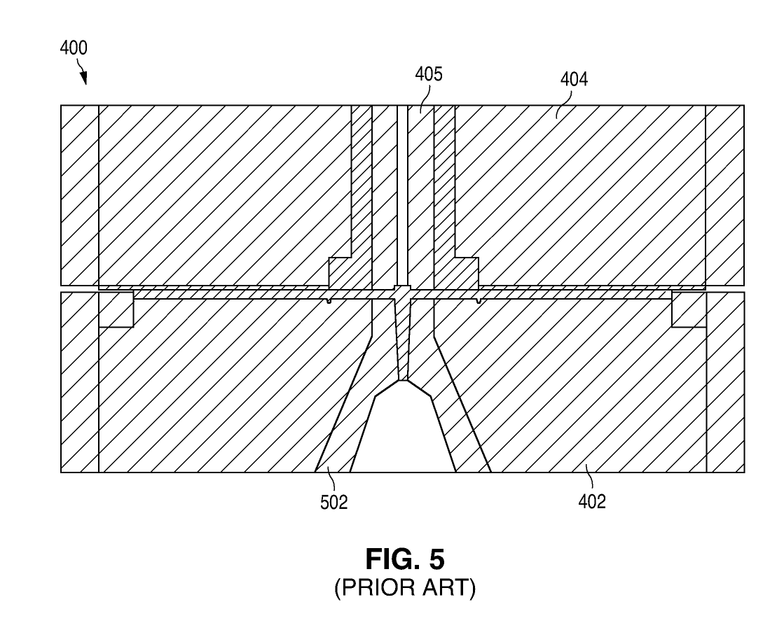

Use of the same reference numbers in different figures indicates similar or identical elements.

### DETAILED DESCRIPTION OF THE INVENTION

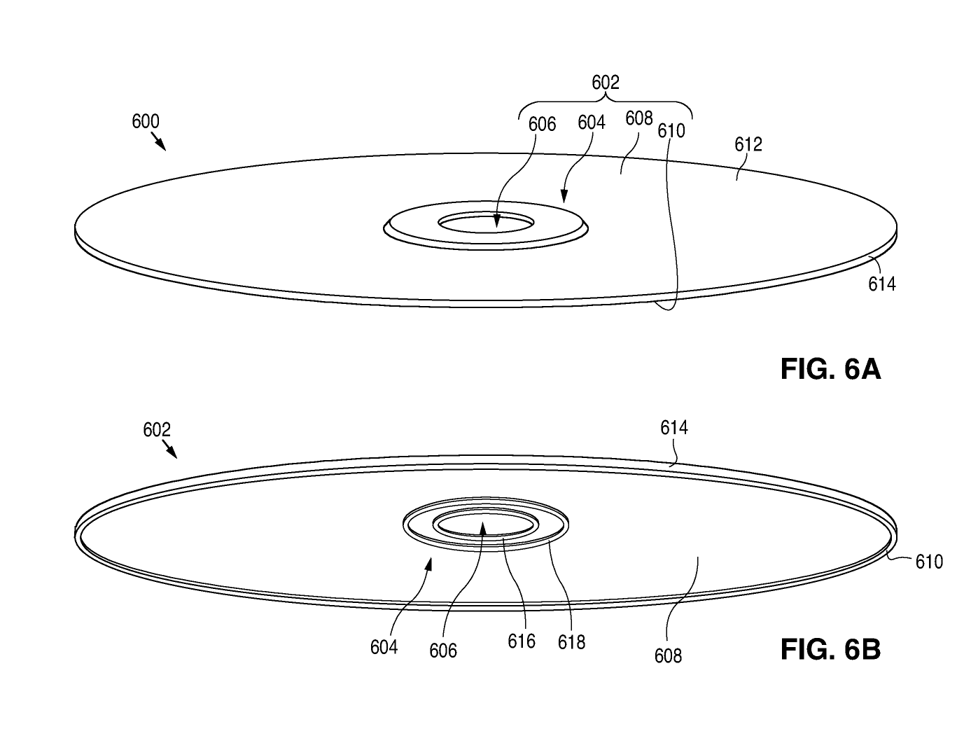

FIGS. 6A and 6B are perspective top and bottom views of a flexible optical disc 600 including a substrate 602 in one or more embodiments of the present disclosure. Substrate 602 has a disc shape but it may have other shapes. Substrate 602 is made of polycarbonate but it may be made with other materials. Substrate 602 has generally flat top and bottom surface with protruding features described hereafter. Optical disc 600 may also include a metal layer on substrate 602, a lacquer layer on the metal layer, and an artwork printed on the lacquer layer.

Referring to FIG. 6A, substrate 602 includes a hub 604 defining a center hole 606, a data storage area 608 extending radially from the hub, and an outer ring 610 protruding downward from an outer perimeter 612 of the data storage area. Outer ring 610 and outer perimeter 612 form part or all of an outer edge 614 of optical disc 600. Referring to FIG. 6B, hub 604 includes an inner ring 616 and an intermediate ring 618 that protrude down from the bottom of substrate 602.

Hub 604 around center hole 606 has a thickness similar to the thickness of a conventional optical disc. That thickness of hub 604 allows conventional optical disc drives to spin and read optical disc 600.

Data storage area 608 has a thickness about half of a conventional optical disc. The thickness of data storage area 608 contributes to the overall 45% or more reduction in raw material use in the production of optical disc 600 when compared to a conventional optical disc. The thickness of data storage area 608 also allows optical disc 600 to be flexible, bending as much as 150 degrees. For example, the rigidity of a polycarbonate disc generally reduces 87% when its thickness is reduced 50%.

Outer edge 614 has a thickness similar to the thickness of a conventional optical disc. The thickness of outer edge 614 provides the strength needed for optical disc 600 to be ejected from conventional slot-loading disc drives.

Outer ring 610 along with inner ring 616 and intermediate ring 618 lift the bottom surface of optical disc 600 up from any supporting surface to minimize scratching of the reading surface. Furthermore, the weight provided by outer ring 610 along the perimeter allows optical disc 600 to rotate with less wobble in data storage area 608.

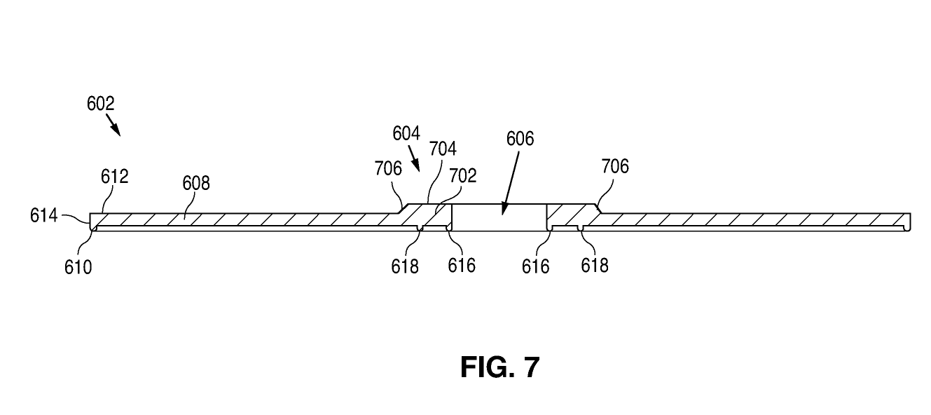

FIG. 7 shows a cross sectional views along a diameter of substrate 602 in one or more embodiments of the present disclosure. Hub 604 includes a hub body 702, and inner ring 616 and intermediate ring 618 protruding down from the hub body. Center hole 606 is defined through hub body 702 and inner ring 616. Hub body 702 includes a cylindrical base and a conical top on the cylindrical base, which together appear trapezoidal in the cross section. The conical top has a flat top surface 704 and a sloped side surface 706, which make printing artwork on hub 604 easier. Data storage area 608 extend radially from the cylindrical base of hub body 702 so its bottom surface is suspended from any supporting surface by inner ring 616, intermediate ring 618, and outer ring 610.

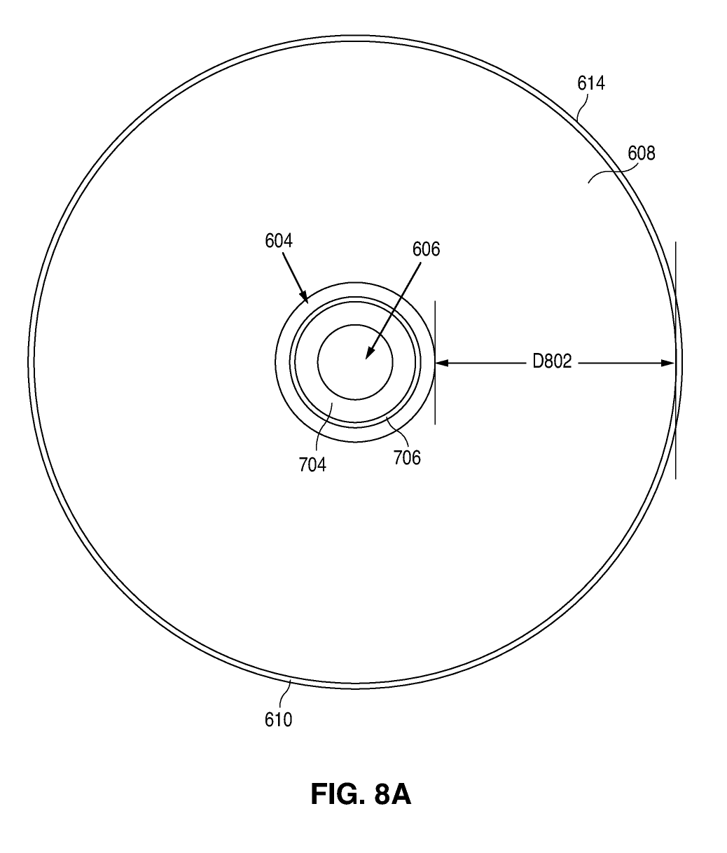

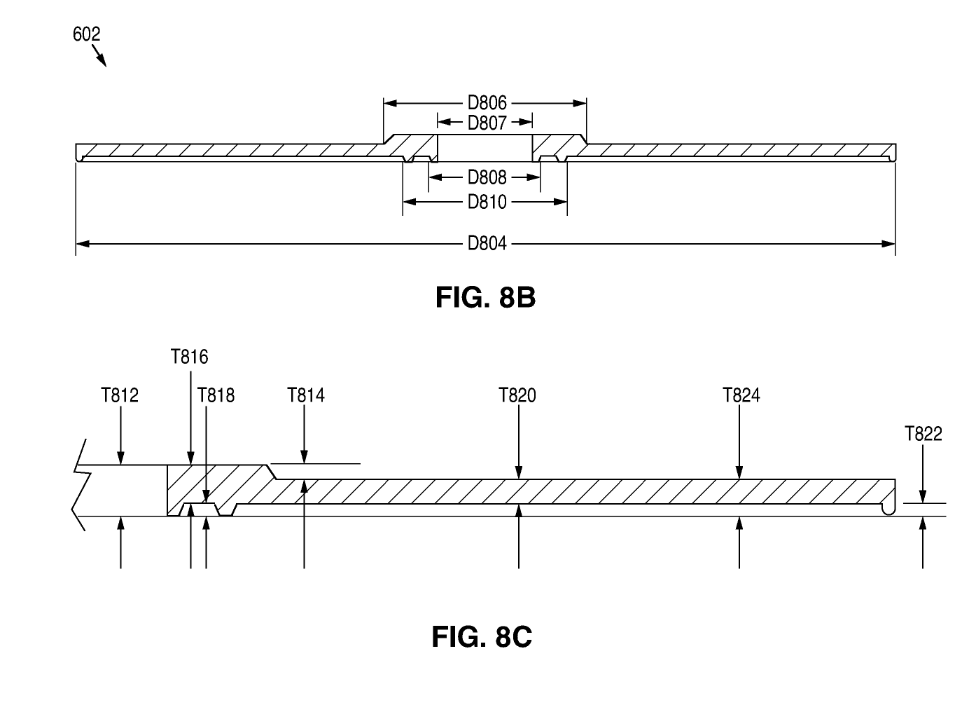

FIGS. 8A, 8B, and 8C show top, cross section, and enlarged cross section views of optical disc 600 with various labeled dimensions in one or more embodiments of the present disclosure. Referring to FIG. 8A, data storage area 608 has a radius D802 that extends 24 millimeters (mm) to 58 mm from the disc center.

Referring to FIG. 8B, substrate 602 has a diameter D804 of about 120 mm. Hub 604 (FIG. 6) has a diameter D806 of about 26 mm to 34 mm, such as 34 mm. Center hole 606 (FIG. 6) has a diameter D807 of about 15 mm. Inner ring 616 (FIG. 6) has a diameter D808 of about 15 mm to 20 mm, such as 19 mm. Intermediate ring 618 (FIG. 6) has a diameter D810 of about 22 mm to 28 mm, such as 28 mm.

Referring to FIG. 8C, center hole 606 (FIG. 6) has a depth T812 of about 0.85 mm to 1.2 mm, such as 1.2 mm. The thickest portion of hub 604 also has a thickness of T812 (e.g., from flat top surface 704 (FIG. 7) to the bottom of inner ring 616 (FIG. 6) or intermediate ring 618 (FIG. 6)). Top flat surface 704 (FIG. 7) of hub body 702 (FIG. 7) is taller than data storage area 608 (FIG. 6) by a height T814 of about 0.05 mm to 0.25 mm, such as 0.25 mm. Hub body 702 has a thickness T816 of about 0.65 mm to 1.1 mm, such as 1.1 mm. Inner ring 616 and intermediate ring 618 have a thickness T818 of about 0.15 mm to 0.45 mm, such as 0.4 mm. Data storage area 608 has a thickness T820 of about 0.53 mm to 0.67 mm, such as 0.67 mm, which is about half the thickness of a conventional optical disc. Outer ring 610 (FIG. 6) has a thickness T822 of about 0.15 mm to 0.45 mm, such as 0.4 mm. Outer edge 614 (FIG. 6) has a thickness T824 of about 0.7 mm to 1.1 mm, such as 1.1 mm.

Hub 604 around center hole 606 has a thickness of about 0.85 mm to 1.2 mm, such as 1.2 mm. This thickness allows optical disc 600 to be rotated and read by conventional optical disc drives. Thickness T820 data storage area and thickness T822 of outer ring 610 are of a same order of magnitude (10⁻¹). The sum of thicknesses T820 and T822 provide thickness T824 that makes outer edge 614 sufficiently rigid to provide the strength needed for optical disc 600 to be ejected from conventional slot-loading disc drives.

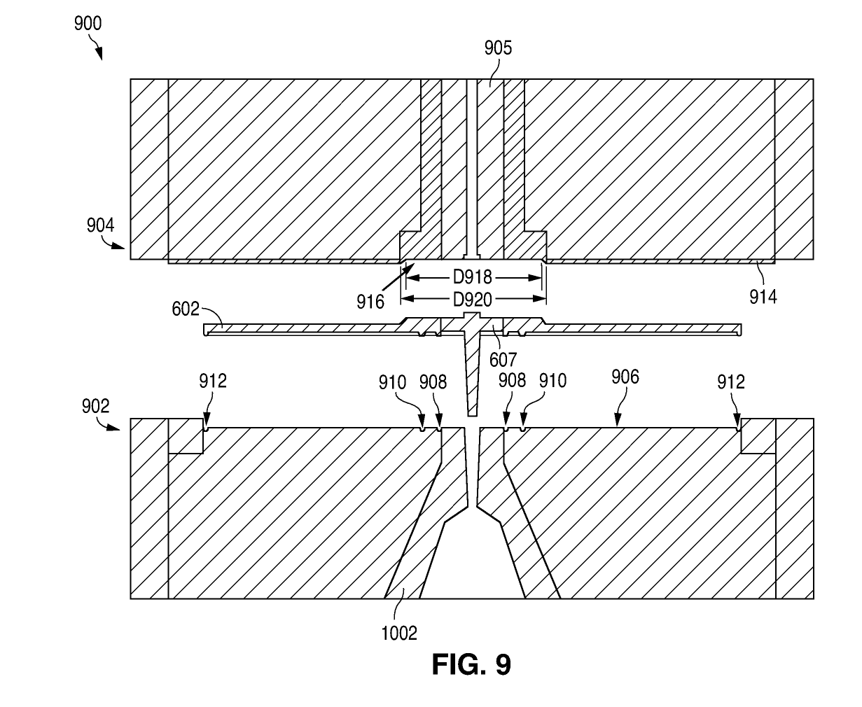

FIG. 9 shows a mold 900 for forming substrate 602 (FIG. 6) in one or more embodiments of the present disclosure. Mold 900 is part of a plastic injection molding machine. Mold 900 includes a first mold half 902 and a second mold half 904. First mold half 902 includes a space 906 for forming the bottom pattern of substrate 602. Space 906 includes recesses 908, 910, and 912 for forming inner ring 616, intermediate ring 618, and outer ring 610.

Second mold half 904 holds a master stamper 914 to imprint data onto the top surface of substrate 602. Second mold half 904 also define a space 916 that forms the conical top of hub 604. Space 916 has a conical shape with a flat top having a diameter D918 of about 24 mm to 32 mm (e.g., 32 mm), and a flat bottom having a diameter of D920 of about 26 mm to 34 mm (e.g., 34 mm).

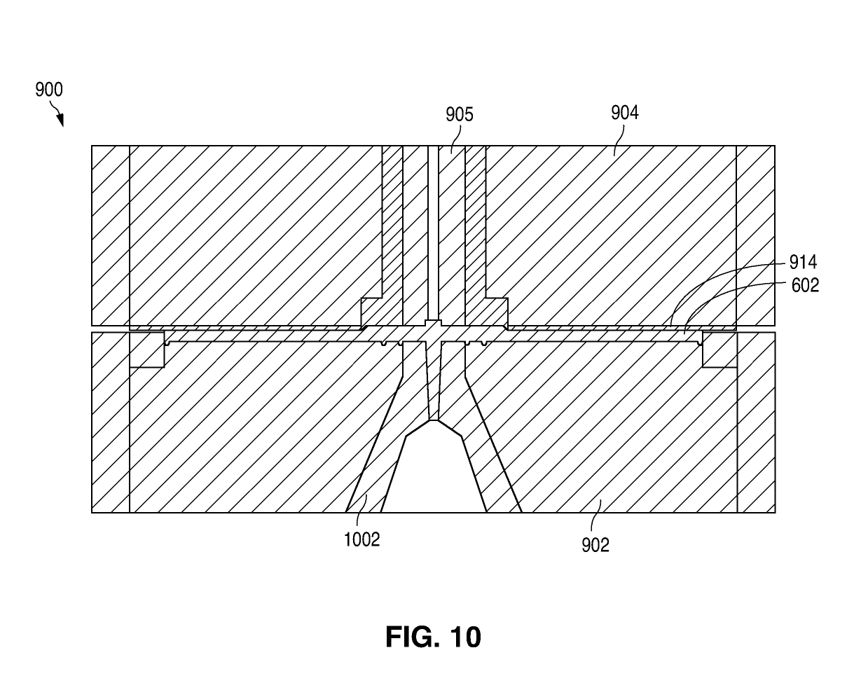

FIG. 10 shows when mold 900 is closed. First mold half 904 defines a sprue bushing 1002 for receiving the molten substrate material from the injection cylinder nozzle. Referring back to FIG. 9, a punch 905 cuts a central sprue 607 from substrate 602 to form center hole 606 after the substrate material hardens. Mold halves 902 and 904 are then separated and substrate 602 is removed.

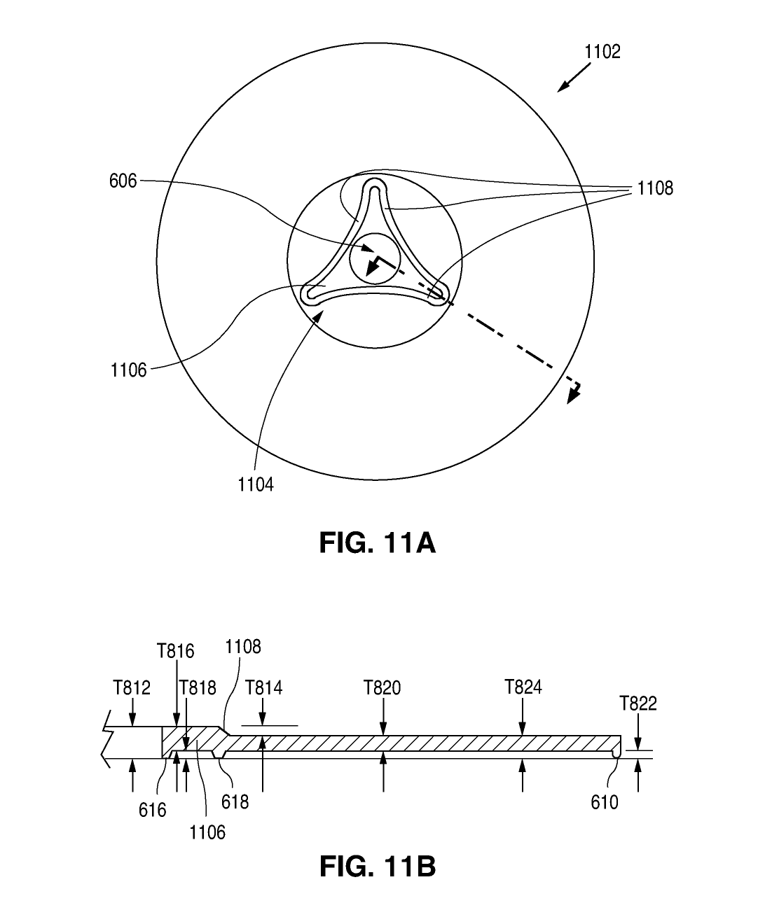

FIGS. 11A and 11B show top and cross sectional views of a substrate 1102 for an optical disc in one or more embodiments of the present disclosure. Substrate 1102 is similar to substrate 602 but they have different hub body designs. Substrate 1102 includes a hub 1104 having a hub body 1106 with a generally triangular top portion on a cylindrical bottom portion. The triangular top portion has three curved (from top) and sloped (from cross section) sides 1108. Similar to hub body 702, inner ring 616 and intermediate ring 618 protrude down from hub body 1106. The dimensions of substrate 1102 are similar to those of substrate 602 and have been labeled accordingly in FIG. 11B.

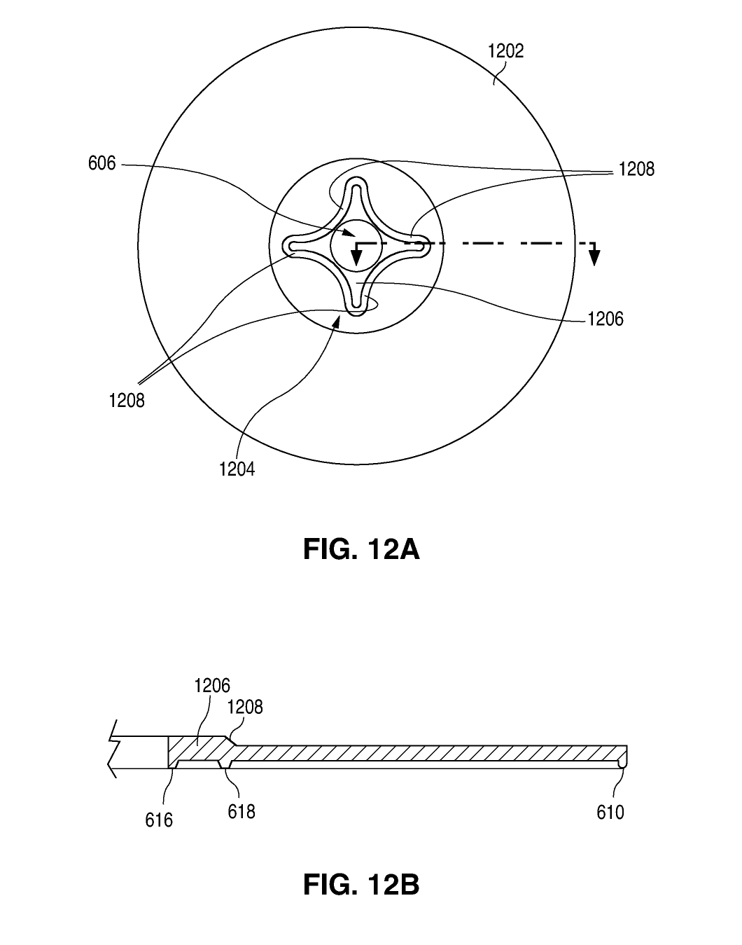

FIGS. 12A and 12B show top and cross sectional views of a substrate 1202 for an optical disc in one or more embodiments of the present disclosure. Substrate 1202 is similar to substrate 1102 but they have different hub body designs. Substrate 1202 includes a hub 1204 having a hub body 1206 with a generally diamond-shaped top portion on a cylindrical bottom portion. The diamond-shaped top portion has four curved (from top) and sloped (from cross section) sides 1208. Similar to hub body 1106, inner ring 616 and intermediate ring 618 protrude down from hub body 1206. The dimensions of substrate 1202 are similar to those of substrate 1102.

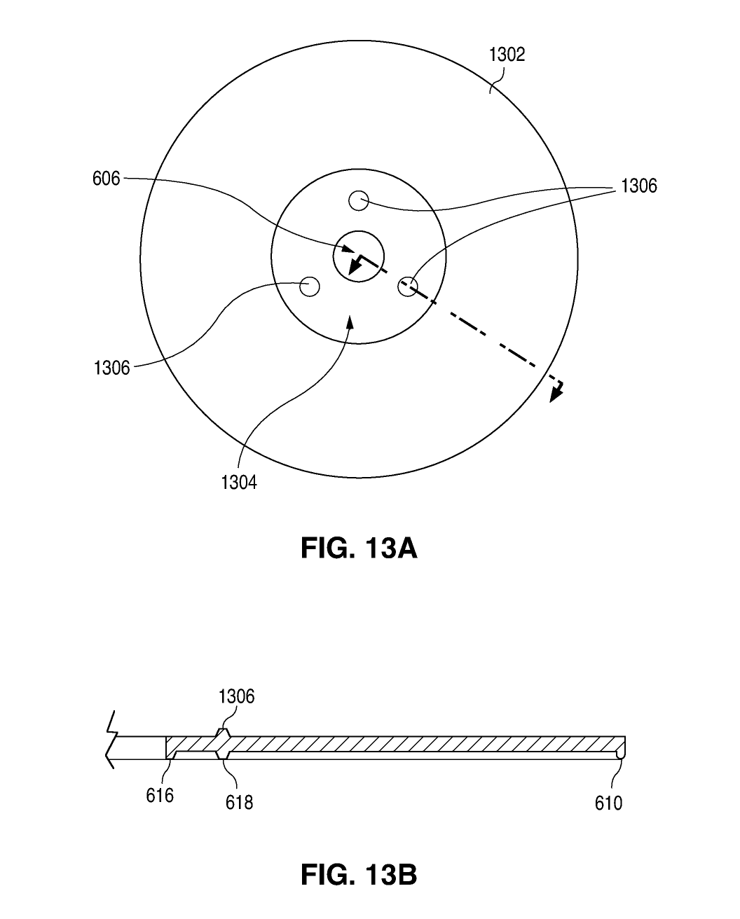

FIGS. 13A and 13B show top and cross sectional views of a substrate 1302 for an optical disc in one or more embodiments of the present disclosure. Substrate 1302 is similar to substrate 602 but they have different hub body designs. Substrate 1302 includes a hub 1304 having a cylindrical hub body with generally flat top and bottom surfaces, three bumps 1306 protruding up from the flat top surface, and inner ring 616 and intermediate ring 618 protruding down from the flat bottom surface. Bumps 1306 are located over intermediate ring 618 and equally spaced apart. The total thickness of hub 1304 through bumps 1306 and intermediate ring 618 is similar to the thickness of a conventional optical disc (e.g., 1.2 mm or less). The thickness of hub 1304 at bumps 1306 and intermediate ring 618 allows conventional optical disc drives to spin and read the optical disc. The other dimensions of substrate 1302 are similar to those of substrate 602.

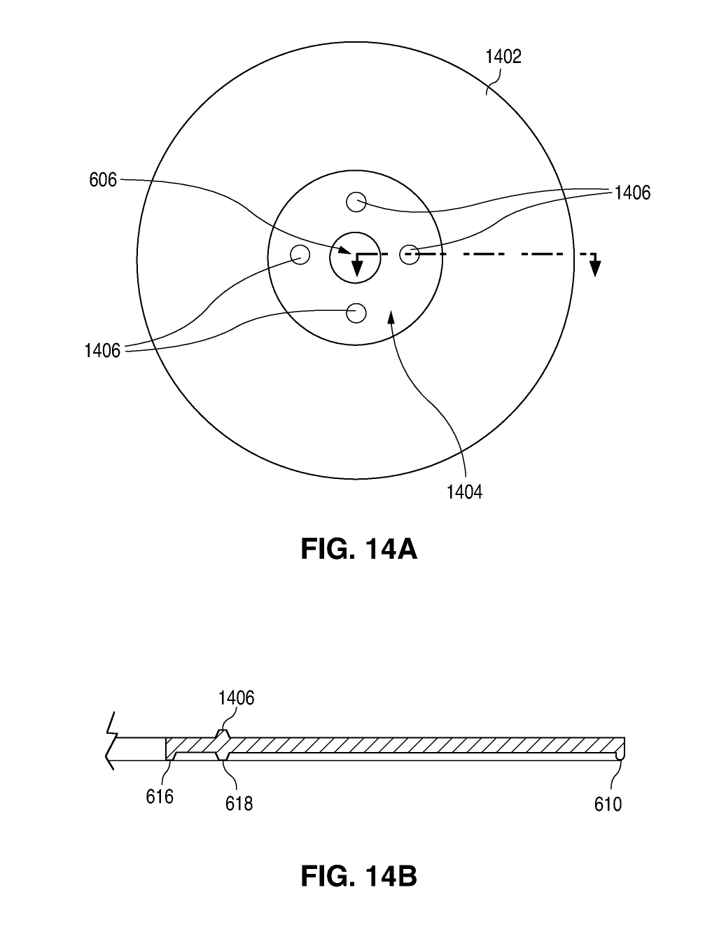

FIGS. 14A and 14B show top and cross sectional views of a substrate 1402 for an optical disc in one or more embodiments of the present disclosure. Substrate 1402 is similar to substrate 1302 but they have different hub body designs. Substrate 1402 includes a hub 1404 having a cylindrical hub body with generally flat top and bottom surfaces, four bumps 1406 protruding up from the flat top surface, and inner ring 616 and intermediate ring 618 protruding down from the flat bottom surface. Bumps 1406 are located over intermediate ring 618 and equally spaced apart. The dimensions of substrate 1402 are similar to those of substrate 1302.

Various other adaptations and combinations of features of the embodiments disclosed are within the scope of the invention. Numerous embodiments are encompassed by the following claims.

1. An optical disc, comprising:
a substrate, comprising:
a hub defining a center hole;
a data storage area extending radially from the hub, the data storage area being thinner than a thickest portion of the hub; and
an outer ring protruding down from an outer perimeter of the data storage area, wherein thicknesses of the outer ring and the data storage area are of a same order of magnitude, and an outer edge of the optical disc comprises the outer ring and the perimeter of the data storage area.

2. The optical disc of claim 1, wherein the hub comprises a hub body and an inner ring protruding down from the hub body.

3. The optical disc of claim 2, wherein the hub body and the inner ring define the center hole.

4. The optical disc of claim 3, wherein the hub further comprises an intermediate ring protruding down from the hub body, the intermediate ring having a larger diameter than the inner ring.

5. The optical disc of claim 4, wherein the hub body comprises a conical top portion on a cylindrical bottom portion, the conical top portion comprises a flat top surface and a sloped side surface, the data storage area extends laterally from the cylindrical bottom portion of the hub body, and the inner ring and the intermediate ring protrude down from the cylindrical bottom portion.

6. The optical disc of claim 5, wherein:
the thickest portion of the hub has a thickness of about 0.85 mm to 1.2 mm;
the data storage area has a thickness of about 0.53 mm to 0.67 mm;
the outer ring has a thickness of about 0.15 mm to 0.45 mm; and
the outer edge of the optical disc has a thickness of about 0.7 mm to 1.1 mm.

7. The optical disc of claim 6, wherein the hub body has a thickness of about 0.65 mm to 1.1 mm.

8. The optical disc of claim 7, wherein the inner and the intermediate rings have thicknesses of about 0.15 mm to 0.45 mm.

9. The optical disc of claim 8, wherein the flat top surface of the conical top portion is taller than the data storage area by 0.05 mm to 0.25 mm.

10. The optical disc of claim 9, wherein the center hole has a depth of about 0.85 mm to 1.2 mm.

11. The optical disc of claim 4, wherein the hub body comprises a generally triangular top portion on a cylindrical bottom portion, the triangular top portion comprise a flat top surface and sloped side surfaces, the data storage area extends laterally from the cylindrical bottom portion of the hub body, and the inner and the intermediate rings protrude down from the cylindrical bottom portion.

12. The optical disc of claim 4, wherein the hub body comprises a generally diamond-shaped top portion on a cylindrical bottom portion, the diamond-shaped top portion comprise a flat top surface and sloped side surfaces, the data storage area extends laterally from the cylindrical bottom portion of the hub body, the inner and the intermediate rings protruding down from the cylindrical bottom portion.

13. The optical disc of claim 4, wherein the hub body comprises flat top and bottom surfaces, the hub further comprises bumps protruding up from the flat top surface, the inner and the intermediate rings protrude down from the flat bottom surface, and the bumps are located over the intermediate ring.

14. The optical disc of claim 1, wherein the outer edge of the optical disc has a thickness of about 0.7 mm to 1.1 mm.

15. The optical disc of claim 14, wherein the data storage area has a thickness of about 0.53 mm to 0.67 mm, and the outer ring has a thickness of about 0.15 mm to 0.45 mm.

16. A method for manufacturing a substrate for an optical disc, comprising:
providing first and second mold halves of a mold, the mold halves defining spaces for:
a hub defining a center hole;
a data storage area extending radially from the hub, the data storage area being thinner than a thickest portion of the hub; and
an outer ring protruding down from an outer perimeter of the data storage area, wherein thicknesses of the outer ring and the data storage area are of a same order of magnitude, and an outer edge of the optical disc comprises the outer ring and the perimeter of the data storage area;
providing a master stamper in one of the mold halves;
closing the mold; and
introducing a substrate material into the mold to form the substrate.

17. The method of claim 16, wherein the hub comprises a hub body and an inner ring protruding down from the hub body.

18. The method of claim 17, wherein the hub body and the inner ring define the center hole.

19. The method of claim 18, wherein the hub further comprises an intermediate ring protruding down from the hub body, the intermediate ring having a larger diameter than the inner ring.

20. The method of claim 19, wherein the hub body comprises a conical top portion on a cylindrical bottom portion, the conical top portion comprises a flat top surface and a sloped side surface, the data storage area extends laterally from the cylindrical bottom portion of the hub body, and the inner ring and the intermediate rings protrude down from the cylindrical bottom portion.

21. The method of claim 19, wherein the hub body comprises a generally triangular top portion on a cylindrical bottom portion, the triangular top portion comprise a flat top surface and sloped side surfaces, the data storage area extends laterally from the cylindrical bottom portion of the hub body, and the inner ring and the intermediate ring protrude down from the cylindrical bottom portion.

22. The method of claim 19, wherein the hub body comprises a generally diamond-shaped top portion on a cylindrical bottom portion, the diamond-shaped top portion comprise a flat top surface and sloped side surfaces, the data storage area extends laterally from the cylindrical bottom portion of the hub body, the inner and the intermediate rings protruding down from the cylindrical bottom portion.

23. The method of claim 19, wherein the hub body comprises flat top and bottom surfaces, the hub further comprises bumps protruding up from the flat top surface, the inner and the intermediate rings protrude down from the flat bottom surface, and the bumps are located over the intermediate ring.

24. The method of claim 14, wherein the first mold half defines a space for forming the hub, and the second mold half defines spaces for forming the inner, the intermediate, and the outer rings.
